(19) United States
(12) Patent Application Publication
(10) Pub. No.: US 2011/0139833 A1
(43) Pub. Date: Jun. 16, 2011

(54) CLOTHES HANGER AND METHOD OF MAKING SAME

(76) Inventor: Chi Hung CHEUNG, Hong Kong (HK)

(21) Appl. No.: 12/700,712

(22) Filed: Feb. 4, 2010

Related U.S. Application Data
(60) Provisional application No. 61/285,552, filed on Dec. 11, 2009.

(51) Int. Cl. A41D 27/22; B29C 45/16

(52) U.S. Cl. 223/86; 264/129

(57) ABSTRACT

A clothes hanger includes a main unit and a box. The main unit has an opening thereon and includes a front side and a back side. The box is detachably embedded in the opening and includes a front side and a back side. The front side shape of the box is compatible with the front side shape of the main unit at the opening. The back side shape of the box is compatible with the back side shape of the main unit at the opening and different from the front side shape of the box. The thickness of the box is the same as the thickness of the main unit so that the box may be completely embedded in the main unit.

### CROSS-REFERENCE TO RELATED APPLICATIONS

This application claims the benefit of U.S. Provisional Patent Application Ser. No. 61/285,552, filed on Dec. 11, 2009; the contents of which is hereby incorporated by reference.

### FIELD OF THE PATENT APPLICATION

The present patent application generally relates to household items for everyday living and more particularly to a clothes hanger and a method of making the same.

### BACKGROUND

It is generally desired to have clothes that are hanged on a clothes hanger, the clothes hanger, and a wardrobe containing the clothes hanger filled with fragrance. Many conventional clothes hangers are flocked so as to achieve an anti-slippery effect. However, flocked clothes hangers have problems that some of the flocks may fall off, which may cause irritation to people with sensitive noses.

### SUMMARY

The present patent application is directed to a clothes hanger and a method for making a clothes hanger. In one aspect, the clothes hanger includes a main unit, the main unit having an opening thereon and including a front side and a back side; and a box detachably embedded in the opening, the box including a front side and a back side. The front side shape of the box is compatible with the front side shape of the main unit at the opening. The back side shape of the box is compatible with the back side shape of the main unit at the opening and different from the front side shape of the box.

The front side of the box and the front side of the main unit at the opening may respectively have a rectangular shape. The back side of the box may have a rectangular shape with a convex portion on an upper side thereof. The back side of the main unit at the opening may have a rectangular shape with a concave portion in an upper sidewall thereof.

The back side of the box may further include an elongated protrusion on a lower side thereof. The back side of the main unit at the opening may further include an elongated groove in a lower sidewall thereof.

The concave portion of the main unit and the convex portion of the box may respectively have a shape of a semicircle.

The thickness of the box may be the same as the thickness of the main unit so that the box may be completely embedded in the main unit.

The box may be configured to hold a fragrant or antibacterial material and include a plurality of holes formed thereon.

At least a part of a surface of the main unit may be sprayed with a synthetic rubber paint.

In another aspect, the present patent application provides a clothes hanger including a main unit, the main unit having an opening thereon and including a front side and a back side; and a box detachably embedded in the opening, the box including a front side and a back side. The front side shape of the box is compatible with the front side shape of the main unit at the opening. The back side shape of the box is compatible with the back side shape of the main unit at the opening and different from the front side shape of the box. The thickness of the box is the same as the thickness of the main unit so that the box may be completely embedded in the main unit.

In yet another aspect, the present patent application provides a method for making a clothes hanger. The method includes forming a main unit by injection molding using a mold, the main unit including a front side and a back side; at the same time of forming the main unit, forming an opening on the main unit; forming a box by injection molding using another mold, the box including a front side and a back side; and spraying a synthetic rubber paint on at least a part of a surface of the main unit so as to achieve an anti-slippery effect. The front side shape of the box is formed to be compatible with the front side shape of the main unit at the opening. The back side shape of the box is formed to be compatible with the back side shape of the main unit at the opening and different from the front side shape of the box. The thickness of the box is formed to be the same as the thickness of the main unit so that the box may be completely embedded in the main unit.

The front side of the box and the front side of the main unit at the opening may be formed to have a rectangular shape respectively. The back side of the box may be formed to have a rectangular shape with a convex portion on an upper side thereof. The back side of the main unit at the opening may be formed to have a rectangular shape with a concave portion in an upper sidewall thereof.

The back side of the box may be formed to further include an elongated protrusion on a lower side thereof. The back side of the main unit at the opening may be formed to further include an elongated groove in a lower sidewall thereof.

The concave portion of the main unit and the convex portion of the box may be formed to have a shape of a semicircle respectively.

The step of forming the box may include forming a plurality of holes on the box.

The method may further include printing a first pattern on the front side of the main unit, followed by an inspection on the completeness of the pattern and a drying process performed using an oven, and printing a second pattern on the back side of the main unit, followed by another inspection on the completeness of the pattern and another drying process performed using an oven.

The step of spraying a synthetic rubber paint on at least a part of a surface of the main unit may include: homogeneously blending a rubber paint, a curing agent and a thinner with a weight ratio of about 10:1:4 so as to make the synthetic rubber paint; uniformly spraying the synthetic rubber paint on the main unit; placing the main unit still for about 5-10 minutes; and heating the main unit for about 25-30 minutes under the temperature of about 60-70 Celsius degrees or for about 2-3 hours under room temperature.

### BRIEF DESCRIPTION OF THE DRAWINGS

FIG. 1A is a perspective view of a back side of a main unit of a clothes hanger according to an embodiment of the present patent application.

FIG. 1B is a perspective view of a front side of the main unit depicted in FIG. 1A.

FIG. 2A is a back view of the main unit depicted in FIG. 1A.

FIG. 2B is a front view of the main unit depicted in FIG. 1A.

FIG. 3 is a perspective front view of an aroma box of the clothes hanger according to the embodiment of FIG. 1A.

FIG. 4 is a perspective back view of the aroma box depicted in FIG. 3.

FIG. 5A is a perspective view of the aroma box depicted in FIG. 3 in a half-opened state.

FIG. 5B is another perspective view of the aroma box depicted in FIG. 3 in a half-opened state.

FIG. 6 is a schematic view of the aroma box depicted in FIG. 3 in a completely opened state.

### DETAILED DESCRIPTION

Reference will now be made in detail to embodiments of the clothes hanger and the method of making the same in the present patent application, examples of which are also provided in the following description. Exemplary embodiments of the clothes hanger and the method of making the same disclosed in the present patent application are described in detail, although it will be apparent to those skilled in the relevant art that some features that are not particularly important to an understanding of the clothes hanger and the method of making the same may not be shown for the sake of clarity.

Furthermore, it should be understood that the clothes hanger and the method of making the same disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

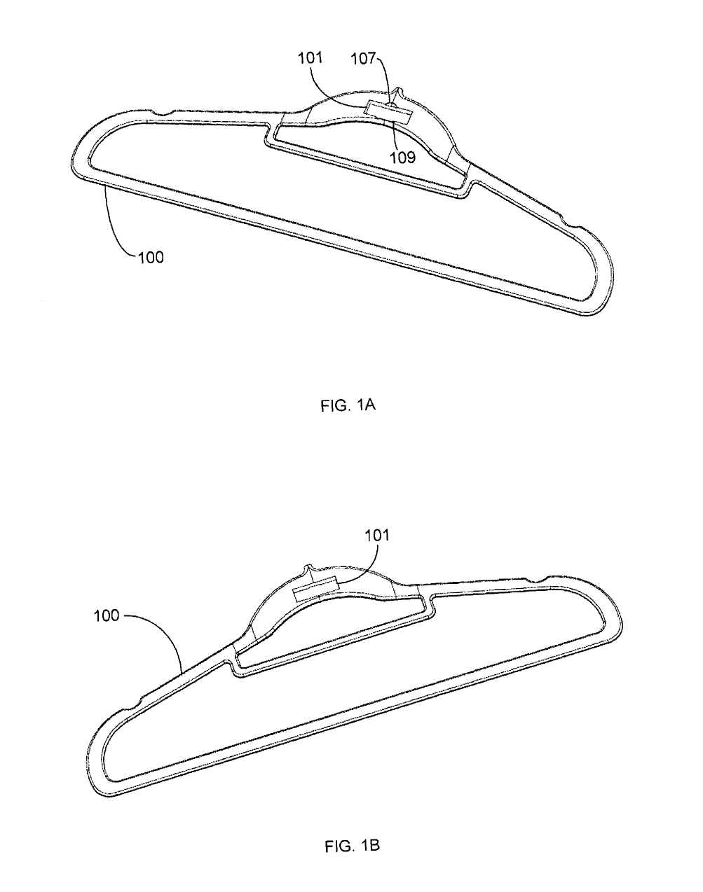

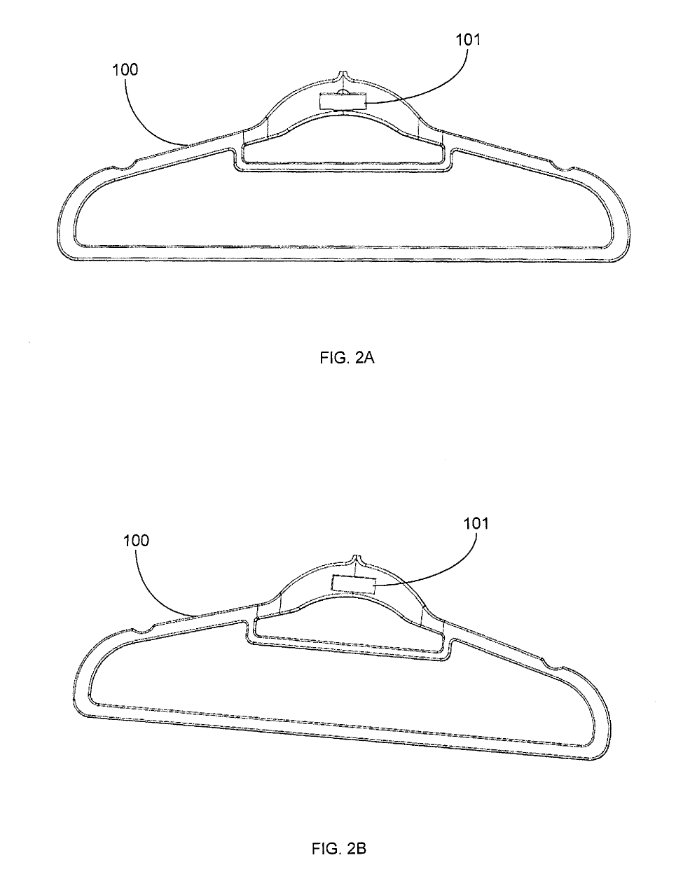

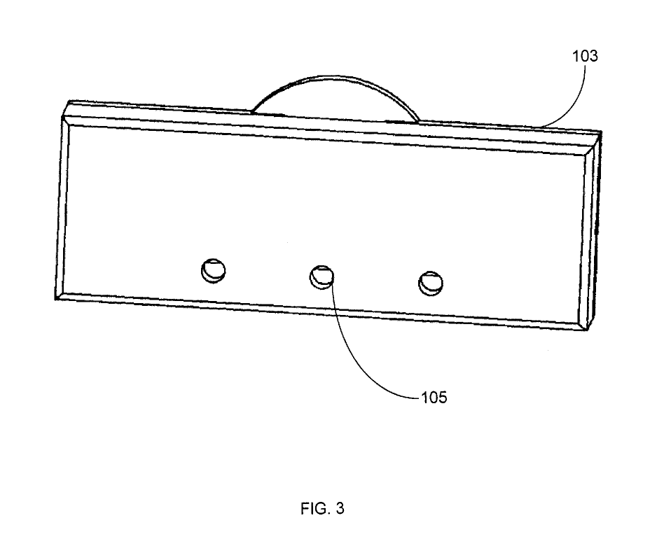

According to an embodiment of the present patent application, a clothes hanger includes a main unit and an aroma box. FIG. 1A is a perspective view of a back side of the main unit. FIG. 1B is a perspective view of a front side of the main unit. FIG. 2A is a back view of the main unit. FIG. 2B is a front view of the main unit. Referring to FIGS. 1A-2B, the main unit 100 includes an opening 101 that is configured to accommodate the aroma box. FIG. 3 is a perspective front view of the aroma box. Referring to FIG. 3, the aroma box 103 is configured to hold perfume or other kinds of fragrant materials therein. A number of air holes 105 are formed on the aroma box 103 for allowing the fragrance of the fragrant material to diffuse out therethrough so that the clothes hanger, clothes on the clothes hanger and a wardrobe containing the clothes hanger and the clothes can be filled with the fragrance. Antibacterial materials may also be placed in the aroma box 103 so as to make the clothes hanger have an antibacterial function.

Referring to FIG. 1A and FIG. 3, the thickness of the aroma box 103 may be the same as that of the main unit 100 so that the aroma box 103 may be completely embedded in the main unit 100. The main unit 100 and the aroma box 103 may be made in an ultra-thin design so as to facilitate the user to make good use of available space of a wardrobe.

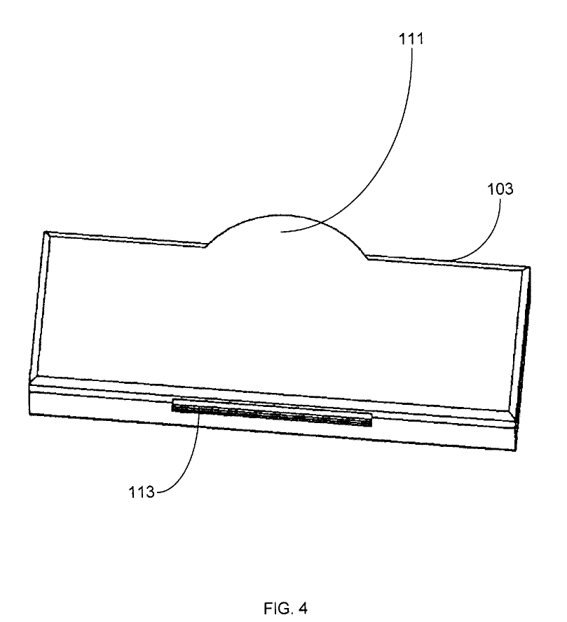

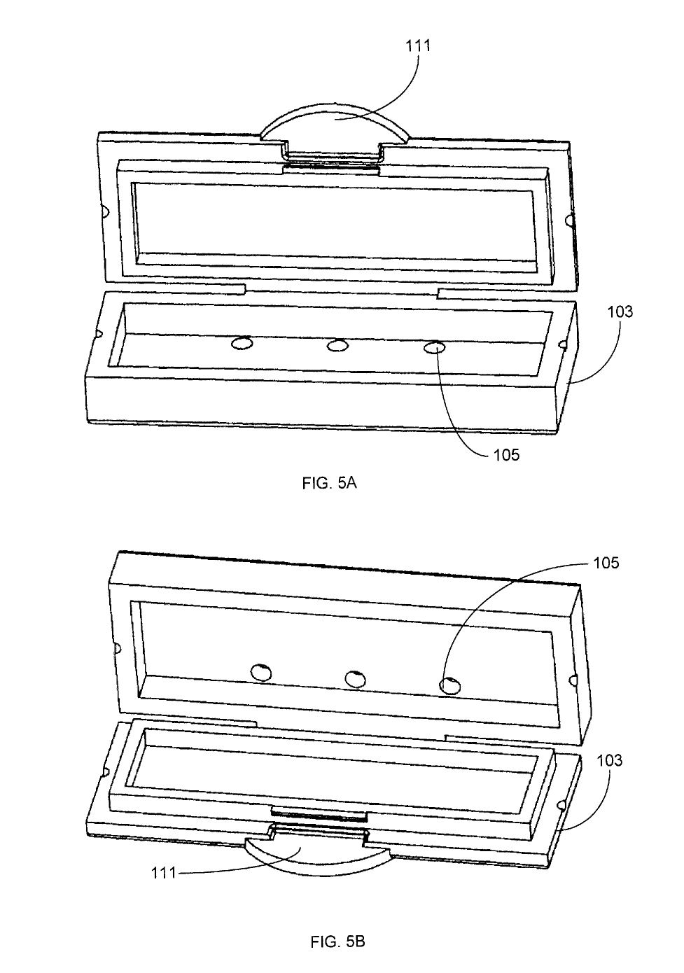

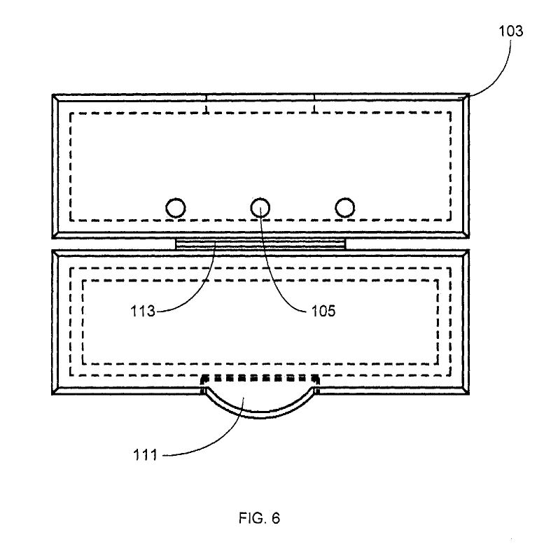

FIG. 4 is a perspective back view of the aroma box in this embodiment. FIG. 5A is a perspective view of the aroma box in a half-opened state. FIG. 5B is another perspective view of the aroma box in a half-opened state. FIG. 6 is a schematic view of the aroma box in a completely opened state. Referring to FIGS. 1A-2B, in this embodiment, the front side shape and the back side shape of the main unit 100 at the opening 101 are different. Correspondingly, referring to FIGS. 3-6, the shape of the aroma box 103 should be compatible with the shape of the main unit 100 at the opening 101. More specifically, the front side shape of the aroma box 103 should be compatible with the front side shape of the main unit 100 at the opening 101, and the back side shape of the aroma box 103 should be compatible with the back side shape of the main unit 100 at the opening 101. This foolproof design enables a user to embed the aroma box 103 only in a correct direction into the main unit 100, and further ensures the aroma box 103 to be completely embedded in the main unit 100. It is also very convenient that the user can take out the aroma box 103 from the main unit 100 or embed the aroma box 103 in the main unit 100 without using any tools.

In this embodiment, referring to FIGS. 1A-1B, the front side of the main unit 100 at the opening 101 is a regular rectangular hole. The back side of the main unit 100 at the opening 101 is a rectangular hole with a concave portion 107 in an upper sidewall thereof and an elongated groove 109 in a lower sidewall thereof. Correspondingly, referring to FIG. 3, the front side of the aroma box 103 has a rectangular shape, and referring to FIG. 4, the back side of the aroma box 103 has a rectangular shape with a convex portion 111 on an upper side thereof and an elongated protrusion 113 on a lower side thereof. Referring to FIG. 6, the elongated protrusion 113 may be further used as a connecting portion between the front side and the back side of the aroma box 103.

Referring to FIGS. 5A-5B, the convex portion 111 of the aroma box may be utilized by a user to open or close the aroma box without using any tools. The user may open the aroma box directly via the convex portion 111 and put his favorite perfume pieces into the aroma box 103.

Referring to FIG. 1A, the concave portion 107 of the main unit 100 at the opening 101 has a shape of a semicircle. Correspondingly, referring to FIG. 4, the convex portion 111 of the aroma box 103 also has a shape of a semicircle. It should be understood that the concave portion 107 of the main unit 100 may have other shapes, for example, an arc, a rectangle, a square, a triangle, and so on. The convex portion 111 of the aroma box 103 may also have the corresponding shapes, for example, an arc, a rectangle, a square, a triangle, and so on.

It is understood that the number of the concave portions 107 of the main unit 100 may be more than one, for example, two, three and so on. The number of the convex portions 111 of the aroma box 103 may also be more than one correspondingly.

The shape of the main unit 100 at the opening 101 may also be appropriately adjusted, as long as the main unit 100 fits well with the aroma box 103 and the aroma box 103 can be completely embedded in the main unit 100. For example, the back side of the main unit 100 at the opening 101 may be a rectangular hole with a convex in the upper sidewall thereof. Correspondingly, the back side of the aroma box 103 may have a rectangular shape with a concave portion on the upper side thereof. Alternatively, the main unit 100 at the opening 101 may have other shapes, such as a circle, an oval, and so on. Correspondingly, the aroma box 103 may also have other shapes such as a circle, an oval, and so on.

In this embodiment, the clothes hanger may be formed by injection molding, and at least a part of a surface of the clothes hanger is sprayed with a synthetic rubber paint so that the clothes hanger has an anti-slippery function preventing clothing from falling off easily. By covering the part of the surface of the clothes hanger with the synthetic rubber paint, a non-slippery effect is achieved, the problem of flocks falling off generated by flocking is avoided, and irritation to people with sensitive noses is avoided.

In another embodiment of the present application, a method of making a clothes hanger as aforementioned is provided. The method includes: forming a main unit plastic member by the method of injection molding using a mold; at the same time of forming the main unit plastic member by injection molding, forming an opening in the main unit plastic member; forming an aroma box by the injection molding method using a mold, the shape of the aroma box being compatible with that of the opening; and spraying a synthetic rubber paint on at least a part of a surface of the main unit plastic member so as to achieve an anti-slippery effect.

After the main unit plastic member is formed, an inspection of the smoothness thereof may be carried out and places on the main unit plastic member that are not smooth are polished. Then patterns may be printed on the main unit plastic member. More specifically, a pattern may be printed on the front side of the main unit plastic member, followed by an inspection on the completeness of the pattern and a drying process performed using an oven. Then another pattern may be printed on the back side of the main unit plastic member, followed by another inspection on the completeness of the pattern and another drying process performed using an oven.

Before spraying the synthetic rubber paint on the main unit plastic member, the surface of the main unit plastic member is cleaned followed by an inspection on the cleanness so that no oil or release agent is remained thereon. The synthetic rubber paint is made by homogeneously blending a rubber paint, a curing agent and a thinner with a weight ratio of 10:1:4. An electronic scale is used to control the weighing precision to be 0.1 gram so as to ensure the feel and adherence of the sprayed coating. After uniformly spraying the synthetic rubber paint on the main unit plastic member, the main unit plastic member is placed still for 5-10 minutes before being dried by an oven. The drying process takes 25-30 minutes under the temperature of 60-70 Celsius degrees or 2-3 hours under room temperature. It takes about 24 hours for the synthetic rubber paint on the main unit plastic member to completely dry. It is noted the synthetic rubber paint should be used within 2 hours after being made; otherwise the unused synthetic rubber paint will be frozen and should be discarded.

In this embodiment, a user may completely embed the aroma box into the clothes hanger when using the clothes hanger. The aroma box may be loaded with perfume pieces so as to fill the space of a wardrobe containing the clothes hanger with fragrance.

While the present patent application has been shown and described with particular references to a number of embodiments thereof, it should be noted that various other changes or modifications may be made without departing from the scope of the present invention.

What is claimed is:

1. A clothes hanger comprising:
a main unit, the main unit having an opening thereon and comprising a front side and a back side; and
a box detachably embedded in the opening, the box comprising a front side and a back side; wherein:
the front side shape of the box is compatible with the front side shape of the main unit at the opening; and the back side shape of the box is compatible with the back side shape of the main unit at the opening and different from the front side shape of the box.

2. The clothes hanger of claim 1, wherein the front side of the box and the front side of the main unit at the opening respectively have a rectangular shape, the back side of the box has a rectangular shape with a convex portion on an upper side thereof, and the back side of the main unit at the opening has a rectangular shape with a concave portion in an upper sidewall thereof.

3. The clothes hanger of claim 2, wherein the back side of the box further comprises an elongated protrusion on a lower side thereof, and the back side of the main unit at the opening further comprises an elongated groove in a lower sidewall thereof.

4. The clothes hanger of claim 2, wherein the concave portion of the main unit and the convex portion of the box respectively have a shape of a semicircle.

5. The clothes hanger of claim 1, wherein the thickness of the box is the same as the thickness of the main unit so that the box may be completely embedded in the main unit.

6. The clothes hanger of claim 1, wherein the box is configured to hold a fragrant or antibacterial material and comprises a plurality of holes formed thereon.

7. The clothes hanger of claim 1, wherein at least a part of a surface of the main unit is sprayed with a synthetic rubber paint.

8. A clothes hanger comprising:
a main unit, the main unit having an opening thereon and comprising a front side and a back side; and
a box detachably embedded in the opening, the box comprising a front side and a back side; wherein:
the front side shape of the box is compatible with the front side shape of the main unit at the opening; the back side shape of the box is compatible with the back side shape of the main unit at the opening and different from the front side shape of the box; and the thickness of the box is the same as the thickness of the main unit so that the box may be completely embedded in the main unit.

9. The clothes hanger of claim 8, wherein the front side of the box and the front side of the main unit at the opening respectively have a rectangular shape, the back side of the box has a rectangular shape with a convex portion on an upper side thereof, and the back side of the main unit at the opening has a rectangular shape with a concave portion in an upper sidewall thereof.

10. The clothes hanger of claim 9, wherein the back side of the box further comprises an elongated protrusion on a lower side thereof, and the back side of the main unit at the opening further comprises an elongated groove in a lower sidewall thereof.

11. The clothes hanger of claim 9, wherein the concave portion of the main unit and the convex portion of the box respectively have a shape of a semicircle.

12. The clothes hanger of claim 8, wherein the box is configured to hold a fragrant or antibacterial material and comprises a plurality of holes formed thereon.

13. The clothes hanger of claim 8, wherein at least a part of a surface of the main unit is sprayed with a synthetic rubber paint.

14. A method for making a clothes hanger, the method comprising:
forming a main unit by injection molding using a mold, the main unit comprising a front side and a back side;
at the same time of forming the main unit, forming an opening on the main unit;
forming a box by injection molding using another mold, the box comprising a front side and a back side; and
spraying a synthetic rubber paint on at least a part of a surface of the main unit so as to achieve an anti-slippery effect; wherein:
the front side shape of the box is formed to be compatible with the front side shape of the main unit at the opening; the back side shape of the box is formed to be compatible with the back side shape of the main unit at the opening and different from the front side shape of the box; and the thickness of the box is formed to be the same as the thickness of the main unit so that the box may be completely embedded in the main unit.

15. The method of claim 14, wherein the front side of the box and the front side of the main unit at the opening are formed to have a rectangular shape respectively, the back side of the box is formed to have a rectangular shape with a convex portion on an upper side thereof, and the back side of the main unit at the opening is formed to have a rectangular shape with a concave portion in an upper sidewall thereof.

16. The method of claim 15, wherein the back side of the box is formed to further comprise an elongated protrusion on a lower side thereof, and the back side of the main unit at the opening is formed to further comprise an elongated groove in a lower sidewall thereof.

17. The method of claim 15, wherein the concave portion of the main unit and the convex portion of the box are formed to have a shape of a semicircle respectively.

18. The method of claim 14, wherein the step of forming the box comprises forming a plurality of holes on the box.

19. The method of claim 14 further comprising printing a first pattern on the front side of the main unit, followed by an inspection on the completeness of the pattern and a drying process performed using an oven, and printing a second pattern on the back side of the main unit, followed by another inspection on the completeness of the pattern and another drying process performed using an oven.

20. The method of claim 14, wherein the step of spraying a synthetic rubber paint on at least a part of a surface of the main unit comprises: homogeneously blending a rubber paint, a curing agent and a thinner with a weight ratio of about 10:1:4 so as to make the synthetic rubber paint; uniformly spraying the synthetic rubber paint on the main unit; placing the main unit still for about 5-10 minutes; and heating the main unit for about 25-30 minutes under the temperature of about 60-70 Celsius degrees or for about 2-3 hours under room temperature.
